(19) United States
(12) Patent Application Publication
(10) Pub. No.: US 2026/0250054 A1
(43) Pub. Date: Aug. 27, 2026

(54) POLYMER COATED PAPER AND PAPERBOARD

(71) Applicant: Stora Enso OYJ, Helsinki (FI)

(72) Inventors: Anders Karlsson, Karlstad (SE); Ville Ribu, Lappeenranta (FI); Isabel Knöös, Kil (SE); Chris Bonnerup, Floda (SE); Åsa Nyflött, Karlstad (SE)

(73) Assignee: Stora Enso OYJ, Helsinki (FI)

(21) Appl. No.: 18/877,506

(22) PCT Filed: May 10, 2023
(86) PCT No.: PCT/IB2023/054831

§ 371 Date: Dec. 20, 2024

(30) Foreign Application Priority Data
Jul. 7, 2022 (SE) 2230223-6

(51) Int. Cl. B65D 65/42; D21H 19/52; D21H 19/54; D21H 19/60; D21H 19/72; D21H 19/82

(52) U.S. Cl. CPC B65D 65/42; D21H 19/60; D21H 19/72; D21H 19/822; D21H 19/52; D21H 19/54

(57) ABSTRACT

The present invention relates to a paper or paperboard based packaging laminate comprising: a paper or paperboard base layer, and a gas barrier layer, wherein said gas barrier layer comprises i) a barrier coating layer comprising a polyvinyl alcohol (PVOH) or a polysaccharide, and ii) an extrusion coated polymer layer 5 comprising ethylene vinyl alcohol (EVOH).

### TECHNICAL FIELD

The present disclosure relates to polymer coated paper and paperboard. More specifically, the present disclosure relates to paper or paperboard comprising at least one extrusion coated polymer layer comprising ethylene vinyl alcohol (EVOH).

### BACKGROUND

Coating of paper and paperboard with plastics is often employed to combine the mechanical properties of the paperboard with the barrier and sealing properties of a plastic film. Paperboard provided with even a relatively small amount of a suitable plastic material can provide the properties needed to make the paperboard suitable for many demanding applications.

Extrusion coating is a process by which a molten plastic material is applied to a substrate, such as paper or paperboard to form a very thin, smooth and uniform layer. The coating can be formed by the extruded plastic itself, or the molten plastic can be used as an adhesive to laminate a solid plastic film onto the substrate. Common plastic resins used in extrusion coating include polyethylene (PE), polypropylene (PP), and polyethylene terephthalate (PET).

Extrusion coating and lamination may be used to achieve, e.g., moisture protection, barrier properties for water vapour, oxygen, aromas, etc., dirt or grease resistance, heat sealability, and/or to impart a desired finish or texture to a substrate surface.

Paper or paperboard as such is generally suitable for the packaging of dry products. However, untreated paperboard is of limited use in direct contact with moist or greasy products, because moisture will affect the mechanical properties of the packaging, and absorbed grease will cause staining of the paper. These effects will impair the protective function as well as their appearance of the packaging.

Extrusion coating or lamination drastically expands the range applications for paper and paperboard. The thin plastic layer imparts resistance to grease and moisture and also in some instances heat resistance. The plastic coatings can also be used for heat sealing. Depending on the application, the paper or paperboard may be extrusion coated on one or both sides.

Although having excellent resistance to grease and moisture, the gas barrier properties of polymer coated paperboards are often still insufficient. Therefore, in order to ensure acceptable gas barrier properties polymer coated paperboard is often provided with one or more layers of aluminum foil. However, due to its high carbon footprint there is a wish to replace aluminum foils in packaging materials in general, and in liquid packaging board in particular. Also, the combination of polymer land aluminum foil layers makes the packaging material hard to recycle efficiently.

Thus, there remains a need for improved solutions to replace aluminum layers in packaging board, while maintaining acceptable liquid, water vapour and oxygen barrier properties.

### DESCRIPTION OF THE INVENTION

It is an object of the present disclosure to provide a paper or paperboard based packaging laminate comprising a polymer based gas barrier layer.

It is a further object of the present disclosure to provide a polymer based gas barrier layer which can be used to replace aluminum layers in packaging board.

The above mentioned objects, as well as other objects as will be realized by the skilled person in the light of the present disclosure are achieved by the various aspects of the present disclosure.

According to a first aspect illustrated herein, there is provided a paper or paperboard based packaging laminate comprising:
a paper or paperboard base layer, and
a gas barrier layer,
wherein said gas barrier layer comprises
   i) a barrier coating layer comprising a polyvinyl alcohol (PVOH) or a polysaccharide, and
   ii) an extrusion coated polymer layer comprising ethylene vinyl alcohol (EVOH).

Paper generally refers to a material manufactured in thin sheets from the pulp of wood or other fibrous substances comprising cellulose fibers, used for writing, drawing, or printing on, or as packaging material.

Paperboard generally refers to strong, thick paper or cardboard comprising cellulose fibers used for boxes and other types of packaging. Paperboard can either be bleached or unbleached, coated or uncoated, and produced in a variety of thicknesses, depending on the end use requirements.

In some embodiments, the base layer has a basis weight in the range of 20-500 g/m², preferably in the range of 80-400 g/m².

In some embodiments, the base layer comprises a multiply paperboard.

In some embodiments, the base layer comprises at least 10 wt %, preferably at least 30 wt %, and more preferably at least 50 wt %, of recycled fibers, based on the total fiber weight of the base layer.

The surface of the paper or paperboard base layer on which the aqueous barrier coating is to be applied may preferably be pre-treated, e.g. by surface sizing or dispersion coating, to decrease the porosity of the surface. This way the coat weight of the barrier coating layer can be reduced.

In some embodiments, the base layer is surface sized on one or both sides, preferably with starch or a starch-based sizing agent.

In some embodiments, the paper or paperboard base layer comprises a mineral coating layer on one or both sides.

The present inventors have now found that a combination of a barrier coating layer comprising a polyvinyl alcohol (PVOH) or a polysaccharide, and an extrusion coated polymer layer comprising ethylene vinyl alcohol (EVOH) provides an effective gas barrier layer which can be used to replace aluminum layers in packaging board. The combination of the barrier coating layer comprising a polyvinyl alcohol (PVOH) and the extrusion coated polymer layer comprising ethylene vinyl alcohol (EVOH) has been found to give rise to excellent oxygen barrier properties, significantly better than the additive effect that could be expected from combining the said layers.

The term coating, as used herein, refers to an operation in which the surface of a substrate is covered with a composition to impart a desired properties, finish or texture to the substrate.

The term extrusion coating, as used herein, refers to an operation in which a molten plastic material is applied to a substrate, such as paper or paperboard to form a very thin, smooth and uniform layer.

In some embodiments, the barrier coating layer is applied on the base layer and the extrusion coated polymer layer is applied on the barrier coating layer.

The barrier coating layer can be a single or multilayer coating wherein the PVOH or polysaccharide can be present in one or several layers.

The barrier coating layer can be applied by any suitable application method. The barrier coating layer may for example be applied by liquid or foam coating methods or by melt extrusion coating methods. In preferred embodiments, the barrier coating layer is applied by liquid or foam coating of a liquid solution or dispersion comprising the PVOH or polysaccharide onto the base layer followed by drying of the liquid solution or dispersion to obtain the barrier coating layer. The liquid of the liquid solution or dispersion is preferably water or an aqueous solution.

The liquid solution or dispersion may be applied to the paper or paperboard base layer using conventional coating or application methods well known in the art. Examples of suitable coating or application methods include, but are not limited to, size press, film press, immersion, spray coating, curtain coating, printing, such as flexography or rotogravure printing, or anilox or gravure or rod coating. Curtain coating is a preferred application method.

In some embodiments, the liquid solution or dispersion is applied in the form a foam. Foam coating is advantageous as it allows for film forming at higher solids content and lower water content compared to a non-foamed coating. The lower water content of a foam coating also reduces the problems with rewetting of the base layer. The foam may be formed using a polymeric or non-polymeric foaming agent. Examples of polymeric foaming agents include PVOH, hydrophobically modified starch, and hydrophobically modified ethyl hydroxyethyl cellulose.

In some embodiments, the PVOH or polysaccharide of the barrier coating layer is water-soluble or water-dispersible.

In some embodiments, the barrier coating layer comprises at least 50 wt %, preferably at least 70 wt %, of the PVOH or polysaccharide based on the dry weight of the barrier coating layer. The remainder of the barrier coating layer can be made up of other polymeric or non-polymeric coating constituents. In some embodiments, the remainder comprises latex. In some embodiments, the remainder comprises pigments. The barrier coating layer may also consist of, or substantially consist of, the PVOH or polysaccharide.

In some embodiments, the PVOH of the barrier coating layer is selected from the group consisting of PVOH, a copolymer of ethylene and PVOH, and combinations thereof, preferably PVOH.

In some embodiments, the PVOH of the barrier coating layer has a degree of hydrolysis in the range of 80-99 mol %, preferably in the range of 85-99 mol %. A PVOH with such a degree of hydrolysis has been demonstrated to provide exceptional gas barrier properties.

In some embodiments, the polysaccharide of the barrier coating layer is selected from the group consisting of hemicellulose, carboxymethylcellulose (CMC), starch, and combinations thereof, preferably CMC.

Short water-soluble polysaccharides, having a degree of polymerization (DP) of 100 or less, for example an anionic hemicellulose such as xylan, can form good barrier films when combined with longer water-soluble polysaccharides, having a degree of polymerization (DP) of 150 or more, for example carboxymethyl cellulose. In addition to providing barrier films and coatings having excellent oxygen and grease barrier properties, the combination of a relatively high amount of a relatively short water-soluble polysaccharide and a longer water-soluble polysaccharide, makes it possible to prepare aqueous barrier coating compositions with a high total solids content, such as 10, 20 or even 30% by weight or more, while still maintaining a reasonably low viscosity. This allows for the aqueous barrier coating composition to be efficiently applied to a paper or paperboard base layer using conventional coating methods. The high solids content combined with low viscosity reduces transportation costs of the coating composition and makes it possible prepare coatings with high basis weight in a single coating step. A high solids content also reduces the amount of water to be removed when the film or coating is dried, which can reduce the drying energy requirement of the coating process.

Thus, in some embodiments the barrier coating layer comprises 20-80% by weight of a first polysaccharide having a first degree of polymerization (DP1) of at least 150, based on the total solids content of the barrier film or coating; and 20-80% by weight of a second polysaccharide having a second degree of polymerization (DP2) of 100 or less, based on the total solids content of the barrier film or coating;
wherein the ratio of DP1:DP2 is at least 10:1.

In some embodiments, the barrier coating layer comprises a polysaccharide and xylan. In some embodiments, the barrier coating layer comprises CMC and xylan.

In some embodiments, the barrier coating layer further comprises a pigment. The pigment may for example comprise inorganic particles of talcum, silicates, carbonates, alkaline earth metal carbonates and ammonium carbonate, or oxides, such as transition metal oxides and other metal oxides. The pigment may also comprise nano-size pigments such as nanoclays and nanoparticles of layered mineral silicates, for instance selected from the group comprising montmorillonite, bentonite, kaolinite, hectorite and hallyosite.

In some embodiments, the coat weight of the barrier coating layer is in the range of 4-12 g/m², and preferably in the range of 5-10 g/m².

In some embodiments, the barrier coating layer comprises a PVOH and the coat weight of the barrier coating layer is in the range of 4-8 g/m².

In some embodiments, the barrier coating layer comprises a polysaccharide and the and the coat weight of the barrier coating layer is in the range of 6-10 g/m², and preferably in the range of 8-10 g/m².

The extrusion coated polymer layer can be a single or multilayer coating wherein the EVOH can be present in one or several layers.

In some embodiments, the extrusion coated polymer layer comprises at least 50 wt %, preferably at least 70 wt %, and more preferably at least 90 wt %, of the EVOH based on the dry weight of the extrusion coated polymer layer. The remainder of the extrusion coated polymer layer can be made up of other polymeric or non-polymeric coating constituents. The extrusion coated polymer layer may also consist of, or substantially consist of, the EVOH.

In some embodiments, the EVOH of the extrusion coated polymer layer has an ethylene content of at least 27 mol %, preferably at least 32 mol %, and more preferably at least 44 mol %. A high content of at least 27 mol % of ethylene facilitates recycling of the paper or paperboard-based packaging laminate and gives rise to better processability by enabling lower temperatures for extrusion. In addition, the inclusion of at least 27 mol % of ethylene in the EVOH improves the moisture resistance, thereby preserving the high gas barrier properties of the PVOH or the polysaccharide also under high relative humidity conditions. A higher content of ethylene normally decreases the oxygen barrier properties of an EVOH film, but by combining the EVOH of the extrusion coated polymer layer with a barrier coating layer comprising PVOH or a polysaccharide, the laminate still shows excellent oxygen barrier properties. In a preferred embodiment, the laminate comprises a barrier coating layer comprising PVOH having a degree of hydrolysis in the range of 80-99 mol %, in combination with an extrusion coated polymer layer comprising EVOH having an ethylene content of at least 27 mol %. This specific combination has been shown to provide exceptional high oxygen barrier properties, particularly under high relative humidity conditions.

In some embodiments, the EVOH of the extrusion coated polymer layer has a melt flow index (MFI, 190° C. and 2.16 kg) in the range of 2-10 g/10 min, preferably in the range of 3-7 g/10 min.

In some embodiments, the coat weight of the extrusion coated polymer layer is in the range of 10-60 g/m², preferably in the range of 10-30 g/m², and more preferably in the range of 10-25 g/m².

In some embodiments, the extrusion coated polymer layer comprises 2-12 g/m² EVOH, preferably 2-10 g/m² EVOH.

In some embodiments, the extrusion coated polymer layer consists of two or more extrusion coated sublayers wherein at least one of the sublayers consists of 2-12 g/m² EVOH, preferably 2-10 g/m² EVOH.

In some embodiments, the extrusion coated polymer layer consists of two or more extrusion coated sublayers wherein at least two of the sublayers each consist of 2-12 g/m² EVOH, preferably 2-10 g/m² EVOH.

In some embodiments, the paper or paperboard based packaging laminate further comprises a protective polymer layer applied on the extrusion coated polymer layer. The protective polymer layer preferably has a composition different from the extrusion coated polymer layer.

In some embodiments, the protective polymer layer is formed by extrusion coating or by extrusion film lamination.

In some embodiments, the protective polymer layer comprises a layer of a thermoplastic polymer, preferably a polyolefin, and more preferably a polyethylene or a polypropylene or a combination thereof. Polypropylene may provide even better moisture protection at high humidity, e.g. in tropical conditions.

In some embodiments, the protective polymer layer further comprises a tie layer which improves adhesion between the extrusion coated polymer layer and the protective polymer layer. The tie layer is preferably polyethylene based, meaning that the tie layer comprises >80 wt %, preferably >95 wt %, and more preferably >98 wt % of polyethylene. A high polyethylene content in the tie layer facilitates recycling of the packaging laminate as the tie layer may be recycled in the same fraction as an outermost polyolefin layer.

In some embodiments, the paper or paperboard based packaging laminate has an oxygen transfer rate (OTR), measured according to the standard ASTM D-3985 at 50% relative humidity and 23° C., of less than 5 cc/m²/24 h, preferably less than 3 cc/m²/24 h, and more preferably less than 2 cc/m²/24 h.

In some embodiments, the paperboard based packaging laminate has a reject rate according to PTS RH 021/97 of less than 30%, preferably less than 20%, more preferably less than 10%.

In some embodiments, the paperboard based packaging laminate has a remaining ash content of less than 5 wt %, and preferably less than 2 wt % upon combustion at 525° C. or 900° C. in accordance with Tappi standard T211 or T413 respectively.

According to a second aspect illustrated herein, there is provided a method for manufacturing a paper or paperboard based packaging laminate, said method comprising:
a) providing a paper or paperboard base layer,
b) applying an aqueous coating composition comprising a polyvinyl alcohol (PVOH) or a polysaccharide to the paper or paperboard base layer and drying the applied aqueous coating composition form a barrier coating layer, and
c) applying a polymer layer comprising ethylene vinyl alcohol (EVOH) to the barrier coating layer by extrusion coating.

The polyvinyl alcohol (PVOH) or polysaccharide of the second aspect may be further defined as set out above with reference to the first aspect.

The ethylene vinyl alcohol (EVOH) of the second aspect may be further defined as set out above with reference to the first aspect.

While the invention has been described with reference to various exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

### EXAMPLES

### Example 1—Preparation of Paperboard Based Packaging Laminates Comprising a Paperboard Base Layer and a Gas Barrier Layer

Paperboard substrates (Performa Light RS, Koppargloss RS, Performa Light PS, and CKB Nude PS) were coated with various coating dispersions as set out in Table 1. RS (reverse side) and PS (print side) refers to the side of the substrate which is coated. The dispersions used were a starch based coating (Perfectafilm X115, Avebe), PVOH (Poval 15-99, Kuraray), carboxymethyl cellulose (CMC, CPKelco), combinations of the PVOH and CMC, and combinations of the CMC with xylan and sorbitol. The dispersions were applied by rod (R20 or R15) and/or InvoTip (IT) coating in two layers with IR drying between applications.

TABLE 1

| | | | Coat | |
|---|---|---|---|---|
| | | | weight | Application |
| Sample | Substrate | Dispersion | (gsm) | method |
| 302 | Performa | Avebe | 5 + 4 | R20 |
| | Light RS | Perfectafilm X115 | | |
| 305 | Performa | PVOH 15-99 | 4 + 2.5 | R20 + IT |
| | Light RS | | | |
| 307 | Performa | PVOH 15-99 + | 2.7 + 2 | IT + IT |
| | Light RS | 20% CMC | | |
| 313 | Performa | CMC | 6 + 5 | R20 |
| | Light RS | | | |
| 314 | Koppargloss | CMC | 6 + 5 | R20 |
| | RS | | | |
| 317 | Performa | CMC | 4.3 + 2.3 | R20 + IT |
| | Light PS | | | |
| XS02 | Performa | 55,5% CMC + | 6 + 5 | R15 |
| | Light RS | 26% Xylan + | | |
| | | 18.5% Sorbitol | | |
| XS04 | CKB Nude | 55.5% CMC + | 6 + 5 | R15 |
| | PS | 26% Xylan + | | |
| | | 18.5% Sorbitol | | |

The dispersion coated substrates were then extrusion coated on the dispersion coated surface with either LDPE/HDPE/LDPE (10 gsm/15 gsm/10 gsm, coated samples denoted 302a, 305a, 307a, 313a, 314a, 317a, XS02a, and XS04a) or EVOH/MAH-grafted LDPE/LDPE (6 gsm/5 gsm/20 gsm, coated samples denoted 302c, 305c, 307c, 313c, 314c, 317c, XS02c, and XS04c) on top of the dispersion barrier layer.

### Example 2—Analysis of Gas Barrier Properties of the Prepared Paperboard Based Packaging Laminates

The paperboard based packaging laminates prepared in Example 1 were analyzed to determine the oxygen and water vapor barrier properties. The oxygen transmission rate (OTR) was measured according to the standard ASTM D-3985 at 50% relative humidity and 23° C., and at 90% relative humidity and 38° C. The water vapor transmission rate (WVTR) was measured according to the standard ASTM F1249 at 50% relative humidity and 23° C. The results are presented in Table 2.

TABLE 2

| | OTR (ml/(m²*24 h)) | | OTR (ml/(m²*24 h)) | | WVTR (g/(m²*24 h)) | |
|---|---|---|---|---|---|---|
| Sample No | 23° C. 50% RH | | 38° C. 90% RH | | 23° C. 50% RH | |
| 302a | 22 | 31 | | | 1.4 | 1.5 |
| 305a | 3.7 | 3.0 | | | 1.3 | 1.4 |
| 307a | 4.0 | 3.7 | | | 1.4 | 1.3 |
| 313a | 15 | 11 | | | 1.4 | 1.3 |
| 314a | 7.44 | 7.82 | | | | |
| 317a | 7.6 | 8.3 | | | | |
| XS02a | 3.9 | 3.3 | | | 1.4 | 1.5 |
| XS04a | 1.3 | 1.1 | | | 1.5 | 1.4 |
| 302c | 1.4 | 1.52 | 46 | 69 | 1.41 | 1.5 |
| 305c | 0.48 | 0.52 | 44 | 66 | 1.34 | 1.34 |
| 307c | 0.6 | 0.68 | 50 | 68 | 1.29 | 1.39 |
| 313c | 1.1 | 1.24 | | | | |
| 314c | 1.08 | 1.12 | | | 1.5 | 1.53 |
| 317c | 1.52 | 1.6 | 77 | 170 | | |
| XS02c | 0.52 | 0.5 | 110* | 196* | 1.47 | 1.42 |
| XS04c | 0.44 | 0.38 | 97 | 57 | 1.24 | 1.31 |

*Equilibrium still not reached after 41 h

1. A paper or paperboard based packaging laminate comprising:
a paper or paperboard base layer, and
a gas barrier layer,
wherein said gas barrier layer comprises
i) a barrier coating layer comprising a polyvinyl alcohol (PVOH) or a polysaccharide, and
ii) an extrusion coated polymer layer comprising ethylene vinyl alcohol (EVOH).

2. The paper or paperboard based packaging laminate according claim 1, wherein the paper or paperboard base layer has a basis weight in a range of 20-500 g/m².

3. The paper or paperboard based packaging laminate according to claim 1, wherein the base layer comprises at least 10 wt % of recycled fibers, based on a total fiber weight of the base layer.

4. The paper or paperboard based packaging laminate according to claim 1, wherein the base layer is surface sized on one or two sides.

5. The paper or paperboard based packaging laminate according to claim 1, wherein the base layer comprises a mineral coating layer on one or two sides.

6. The paper or paperboard based packaging laminate according to claim 1, wherein the barrier coating layer is applied on the base layer and the extrusion coated polymer layer is applied on the barrier coating layer.

7. The paper or paperboard based packaging laminate according to claim 1, wherein the barrier coating layer comprises at least 50 wt % of the PVOH or polysaccharide based on a dry weight of the barrier coating layer.

8. The paper or paperboard based packaging laminate according to claim 1, wherein the PVOH of the barrier coating layer has a degree of hydrolysis in a range of 80-99 mol %.

9. The paper or paperboard based packaging laminate according to claim 1, wherein the polysaccharide of the barrier coating layer is selected from a group consisting of hemicellulose, carboxymethylcellulose (CMC), starch, and combinations thereof.

10. The paper or paperboard based packaging laminate according to claim 1, wherein the barrier coating layer comprises a polysaccharide and xylan.

11. The paper or paperboard based packaging laminate according to claim 1, wherein the barrier coating layer further comprises a pigment.

12. A The paper or paperboard based packaging laminate according to claim 1, wherein a coat weight of the barrier coating layer is in a range of 4-12 g/m².

13. The paper or paperboard based packaging laminate according to claim 1, wherein the barrier coating layer comprises a PVOH and a coat weight of the barrier coating layer is in a range of 4-8 g/m².

14. The paper or paperboard based packaging laminate according to claim 1, wherein the barrier coating layer comprises a polysaccharide and a coat weight of the barrier coating layer is in a range of 6-10 g/m².

15. The paper or paperboard based packaging laminate according to claim 1, wherein the extrusion coated polymer layer comprises at least 50 wt % of the EVOH based on a dry weight of the extrusion coated polymer layer.

16. The paper or paperboard based packaging laminate according to claim 1, wherein the EVOH of the extrusion coated polymer layer has an ethylene content of at least 27 mol %.

17. The paper or paperboard based packaging laminate according to claim 1, wherein the EVOH of the extrusion coated polymer layer has a melt flow index (MFI, 190° C. and 2.16 kg) in a range of 2-10 g/10 min.

18. The paper or paperboard based packaging laminate according to claim 1, wherein the extrusion coated polymer layer comprises 2-12 g/m² EVOH.

19. The paper or paperboard based packaging laminate according to claim 1, wherein the extrusion coated polymer layer comprises two or more extrusion coated sublayers, wherein at least one of the sublayers comprises 2-12 g/m² EVOH.

20. A The paper or paperboard based packaging laminate according to claim 1, further comprising a protective polymer layer applied on the extrusion coated polymer layer.

21. The paper or paperboard based packaging laminate according to claim 1, having an oxygen transfer rate (OTR), measured according to the standard ASTM D-3985 at 50% relative humidity and 23° C., of less than 5 cc/m²/24 h.

22. The paper or paperboard based packaging laminate according to claim 1, having a reject rate according to PTS RH 021/97 of less than 30%.

23. A method for manufacturing a paper or paperboard based packaging laminate, said method comprising:
a) providing a paper or paperboard base layer,
b) applying an aqueous coating composition comprising a polyvinyl alcohol (PVOH) or a polysaccharide to the paper or paperboard base layer and drying the applied aqueous coating composition to form a barrier coating layer, and
c) applying a polymer layer comprising ethylene vinyl alcohol (EVOH) to the barrier coating layer by extrusion coating.
